(19) United States
(12) Patent Application Publication
(10) Pub. No.: US 2015/0154282 A1
(43) Pub. Date: Jun. 4, 2015

(54) DATA SEARCH APPARATUS AND METHOD FOR CONTROLLING THE SAME

(71) Applicants: FUJITSU LIMITED, Kawasaki-shi (JP); The University of Tokyo, Tokyo (JP)

(72) Inventors: Masahiro WATANABE, Kawasaki (JP); Satoshi FUCHIKAMI, Fukuoka (JP); Yoshimasa KADOOKA, Kawasaki (JP); Toshiaki HISADA, Tokyo (JP); Seiryo SUGIURA, Tokyo (JP); Takumi WASHIO, Tokyo (JP); Jun-ichi OKADA, Tokyo (JP)

(73) Assignees: FUJITSU LIMITED, Kawasaki-shi (JP); The University of Tokyo, Tokyo (JP)

(21) Appl. No.: 14/539,261

(22) Filed: Nov. 12, 2014

(30) Foreign Application Priority Data
Nov. 29, 2013 (JP) 2013-247017

(51) Int. Cl. G06F 17/30

(52) U.S. Cl. CPC G06F 17/30625; G06F 17/30333

(57) ABSTRACT

A storage section stores positional information and a physical amount for each of a plurality of physical amount set points arranged in a three-dimensional model. A division section generates division data corresponding to each of a plurality of second regions obtained by dividing a first region including the three-dimensional model so as to make the number of physical amount set points included in each second region equal. When a position in the three-dimensional model is designated, a search section acquires from the storage section a physical amount for a physical amount set point corresponding to the designated position of physical amount set points which division data corresponding to a second region, of the plurality of second regions, including the designated position includes.

### CROSS-REFERENCE TO RELATED APPLICATION

This application is based upon and claims the benefit of priority of the prior Japanese Patent Application No. 2013-247017, filed on Nov. 29, 2013, the entire contents of which are incorporated herein by reference.

### FIELD

The embodiments discussed herein are related to a data search apparatus which makes a search for data and a method for controlling such a data search apparatus.

### BACKGROUND

In recent years various simulations have been done by the use of large-scale computers. For example, heart simulators which reproduce the motions of patients' hearts have been developed. Analysis of the motions of hearts by heart simulators will be useful for supporting heart diagnoses on clinical sites.

A simulation of an internal organ, such as a heart, is done by dividing space by a structured grid or an unstructured grid. With the structured grid nodes that are points at which a calculation is performed in an analysis are arranged along a coordinate system. With the unstructured grid nodes are not arranged along a coordinate system but are arranged irregularly. Usually the unstructured grid is used for doing a simulation of a heart, which is complex in shape and which involves motion. A polyhedral element formed by connecting a plurality of nodes is defined in a simulation of an internal organ and a physical amount in the polyhedral element is calculated.

For example, a physical amount, such as pressure on a heart muscle, is calculated according to elements or nodes in a simulation of a heart. A change in the state of a heart can be grasped, for example, by statistically analyzing calculated physical amounts.

Furthermore, there are cases where it is desirable to designate a specific position on an object of simulation and to display a physical amount at the position. One heart muscle cell may be defined for each element especially in the case of a heart simulator in which there is a need to correctly reproduce the motion of a heart. From the viewpoint of observing simulation results or debugging a simulator, it is important to ascertain a change in physical amount at the position of each element caused by the contraction of heart muscle cells.

For example, in order to display a physical amount at a specific position, a user provides input by operation on a three-dimensional model of a heart for designating the specific position. A computer then makes a search for an element or a node corresponding to the designated position. As the number of elements or nodes increases, time taken to make a search for the element or the node becomes longer. The display of a physical amount at a designated position is performed in this way by interactive operation in approximately real time. Accordingly, a high-speed search is important in efficiently ascertaining a physical amount.

For example, in order to select a relevant element from a coordinate point designated with a mouse and display a physical amount, data is structured and is held in a memory. A high-speed search is made by holding data by the use of a data structure which is easy to search. An octree is known as a data structure which is easy to search. By holding data by the use of an octree, a large region is selected first from the coordinate point designated with the mouse. A narrow divided region in the large region is then selected. This operation is repeated. As a result, there is no need to calculate the distance between the coordinate point designated with the mouse and the center of gravity of each element or each node, so an extraction is performed in a short period of time.
Japanese Laid-open Patent Publication No. 2013-162921
Japanese Laid-open Patent Publication No. 2004-334640
Japanese Laid-open Patent Publication No. 2005-250767
International Publication Pamphlet No. WO2009/031200

With an internal organ such as a heart, however, the following problem arises if division is made by the use of a technique, such as an octree, so as to obtain spaces of equal size. There is variation in the number of positions, such as elements or nodes, in regions after the division at which a physical amount is set. Accordingly, search time varies depending on a region including a position designated as a position at which a physical amount is to be ascertained. As a result, if the number of positions at which a physical amount is set and which are included in the region including the position designated as a position at which a physical amount is to be ascertained is larger than the number of positions at which a physical amount is set and which are included in any other region, the number of times the distance between the position designated as a position at which a physical amount is to be ascertained and a position at which a physical amount is set is calculated increases. This leads to a long search time.

### SUMMARY

According to an aspect, there is provided a data search apparatus including: a memory configured to store positional information and a physical amount for each of a plurality of physical amount set points arranged in a three-dimensional model; and a processor configured to execute a process including: generating division data corresponding to each of a plurality of second regions obtained by dividing a first region including the three-dimensional model so as to make a number of physical amount set points included in each second region equal, and acquiring, at the time of a position in the three-dimensional model being designated, from the memory a physical amount for a physical amount set point corresponding to the designated position of physical amount set points which division data corresponding to a second region, of the plurality of second regions, including the designated position includes.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of the function of a data search apparatus according to a first embodiment;

FIG. 2 illustrates examples of dividing space on the basis of an octree;

FIG. 3 illustrates an example of the hardware configuration of a computer used in a second embodiment;

FIG. 4 is a functional block diagram of the computer according to the second embodiment;

FIG. 5 indicates an example of a data structure in an unstructured grid data storage section;

FIG. 6 illustrates an example of a three-dimensional model of a heart;

FIG. 7 indicates an example of a data structure in a simulation result storage section;

FIG. 8 is a flow chart of an example of a procedure for an octree division data generation process;

FIG. 9 is a flow chart of an example of a procedure for a region division process;

FIG. 10 is a flow chart of a procedure for an eightfold division process;

FIG. 11 illustrates an example of generating an octree;

FIG. 12 indicates an example of a data structure in an octree storage section;

FIG. 13 is a flow chart of an example of a procedure for a search process;

FIG. 14 indicates an example of the display of a physical amount;

FIG. 15 illustrates an example of a key time step; and

FIG. 16 is a flow chart of an example of a procedure for a region division process in a third embodiment.

### DESCRIPTION OF EMBODIMENTS

Embodiments will now be described with reference to the accompanying drawings, wherein like reference numerals refer to like elements throughout. Plural embodiments may be combined if there is no contradiction between them.

### First Embodiment

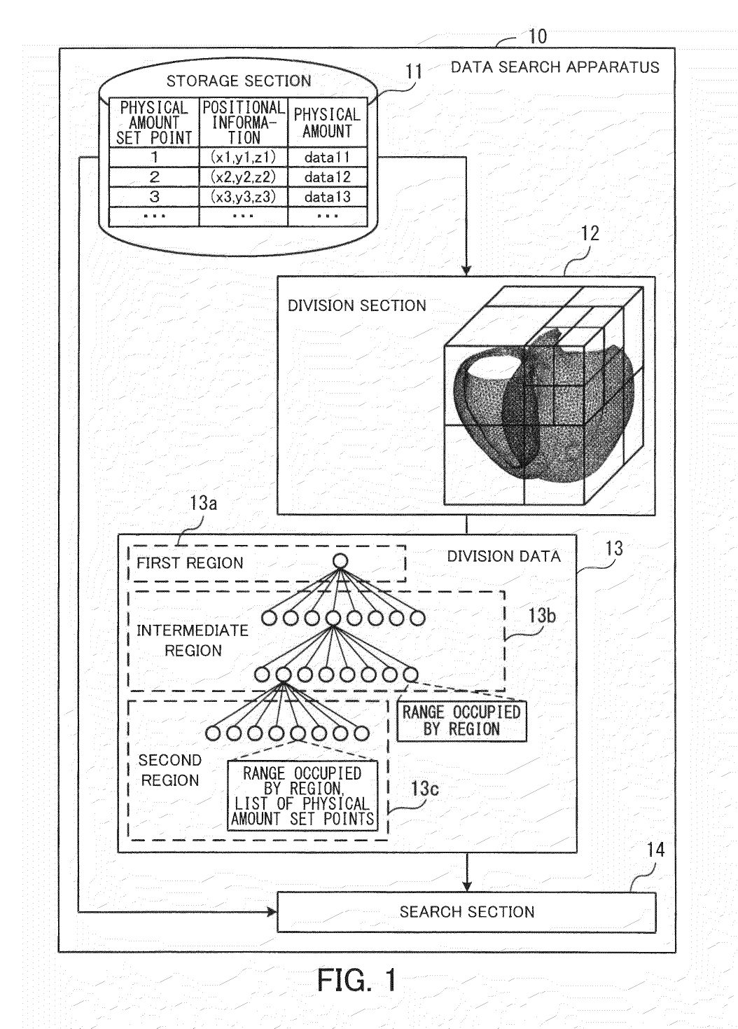

FIG. 1 illustrates an example of the function of a data search apparatus according to a first embodiment. A data search apparatus 10 includes a storage section 11, a division section 12, and a search section 14.

The storage section 11 stores positional information for each of a plurality of physical amount set points arranged in a three-dimensional model and a physical amount at each physical amount set point. For example, if the three-dimensional model is a set of plural elements, then a physical amount set point is the position of each element. The elements which make up the three-dimensional model are, for example, tetrahedrons. The position of an element is, for example, its center of gravity. Furthermore, the physical amount set points may include nodes used for defining the shape of each element. If each element is, for example, a tetrahedron, four nodes indicative of its vertexes may be considered as physical amount set points.

The storage section 11 may be located outside the data search apparatus 10. For example, the storage section 11 may be located in an apparatus connected to the data search apparatus 10 via a network.

The division section 12 refers to the storage section 11 and divides a first region 13a including the three-dimensional model into a plurality of second regions 13c so as to make the number of physical amount set points included in each second region 13c equal. The first region 13a is, for example, a bounding box of the three-dimensional model. The bounding box is a rectangular parallelepiped circumscribed about the three-dimensional model. In addition, the division section 12 generates, for each of the plurality of second regions 13c obtained by the division, division data 13 associated with identification information for physical amount set points included in it.

The division section 12 divides the first region 13a into, for example, a determined number of regions. Furthermore, the division section 12 divides each of the determined number of regions obtained by the division into the determined number of regions. The division section 12 repeats this process. The division section 12 then generates a tree structure in which regions obtained by dividing an upper region are connected to the upper region as its lower regions. If one region is divided into eight regions, then a tree structure generated is an octree. The division section 12 considers a plurality of regions corresponding to leaves of the tree structure as the plurality of second regions 13c.

If the division data 13 is expressed by a tree structure, the first region 13a is assigned to a node which is a root of the tree structure. Furthermore, intermediate regions 13b between the first region 13a and the plurality of second regions 13c which are generated in a process before the generation of the plurality of second regions 13c are assigned to nodes which are knots of the tree structure. In addition, the plurality of second regions 13c are assigned to nodes which are leaves of the tree structure. Information indicative of a spatial range occupied by a corresponding region is set at each node of the tree structure. Furthermore, a list of physical amount set points included in a corresponding region is set at each leaf node.

When a position in the three-dimensional model is designated, the search section 14 specifies a second region 13c, of the plurality of second regions 13c indicated in the division data 13, including the designated position. For example, if the division data 13 is expressed by a tree structure, then the search section 14 searches the tree structure from a root node to leaf nodes for a region including the designated position. When the search section 14 reaches a leaf node, the search section 14 specifies that a region corresponding to the leaf node is a second region 13c including the designated position.

The search section 14 then searches a list of physical amount set points associated with the specified second region 13c in the division data 13 for a physical amount set point indicative of a physical amount at the designated position. For example, the search section 14 refers to the storage section 11 and acquires the position of each physical amount set point associated with the specified second region 13c. The search section 14 then calculates the distance between the designated position and the position of each physical amount set point and determines that a physical amount set point nearest the designated position is a physical amount set point for the designated position. For example, when the search section 14 finds a physical amount set point for the designated position, the search section 14 acquires the value of a physical amount at the physical amount set point from the storage section 11 and outputs the value.

With the above data search apparatus 10 the division section 12 generates, for each of the plurality of second regions 13c in which the number of physical amount set points is equal, the division data 13 associated with identification information for physical amount set points included in it. When a position in the three-dimensional model is designated, the search section 14 searches a list of physical amount set points associated with a specified second region 13c in the division data 13 for a physical amount set point at the designated position.

The number of physical amount set points included in each of the plurality of second regions 13c is equal. Accordingly, whichever one of the plurality of second regions 13c includes the designated position, there is no change in the number of candidate physical amount set points. As a result, whichever position is designated, it does not take a long time to make a search.

The division section 12 and the search section 14 are realized by, for example, a processor included in the data search apparatus 10. Furthermore, the storage section 11 is realized by, for example, a memory included in the data search apparatus 10. If the division section 12 and the search section 14 are realized by the processor, then a control program for the data search apparatus 10 in which processes performed by the division section 12 and the search section 14 are described is prepared. The processor executes the control program and controls the data search apparatus 10. By doing so, the functions of the division section 12 and the search section 14 are realized in the data search apparatus 10.

Furthermore, lines which connect the components illustrated in FIG. 1 indicate a part of communication paths and a communication path other than those illustrated in FIG. 1 may be set.

### Second Embodiment

A second embodiment will now be described. When a simulation result of the motions of a heart is displayed in a second embodiment, a physical amount at a designated point is displayed quickly regardless of a designated position.

If a heart is expressed by a three-dimensional model, there are spaces, such as ventricles, where there are no heart muscles. Accordingly, if a physical amount on, for example, a heart muscle is calculated, there is spatial variation in the number of positions at which a physical amount is calculated. A physical amount is calculated according to elements which make up a three-dimensional model or nodes for defining the shape or position of each element.

In the second embodiment an octree is generated so as to make the number of elements and nodes in a bounding box including a three-dimensional model of a heart uniform.

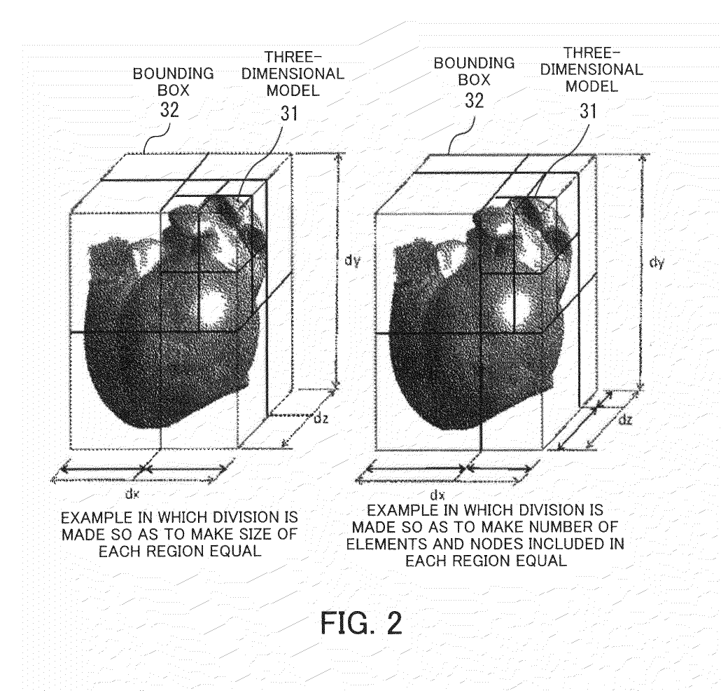

FIG. 2 illustrates examples of dividing space on the basis of an octree. FIG. 2 illustrates two examples of dividing a bounding box 32 including a three-dimensional model 31 of a heart on the basis of an octree. In a left-hand example of FIG. 2, the bounding box 32 is divided so as to make the size of each region obtained by the division equal. In a right-hand example of FIG. 2, the bounding box 32 is divided so as to make the number of elements and nodes included in each region obtained by the division equal. As illustrated in FIG. 2, if the bounding box 32 is divided so as to make the number of elements and nodes included in each region after the division equal, the size of each region after the division is unequal.

When the bounding box 32 is divided into plural regions on the basis of an octree, data for defining the position and size of each region and data indicative of elements and nodes included therein are generated. Of the generated data on the octree, for example, data in the structure above a certain level may be held in a memory and data in the structure below the certain level may be saved in storage.

In addition, there is not much change in the spatial distribution of elements and nodes included in a three-dimensional model of a heart at time steps on a simulation which are close to each other. Therefore, in the second embodiment a key time step is determined according to the amount of a change. Division data obtained at the key time step is copied and is used as division data at another time step.

Furthermore, a heart has a complex shape. In order to ascertain simulation results, in many cases observations are carried out on a cross section perpendicular to a heart axis which connects the apex of the left ventricle and the center of the valve region of the mitral valve. Accordingly, a physical value can be extracted in a short period of time by making one side of a region which surrounds the outside of the heart parallel to the heart axis.

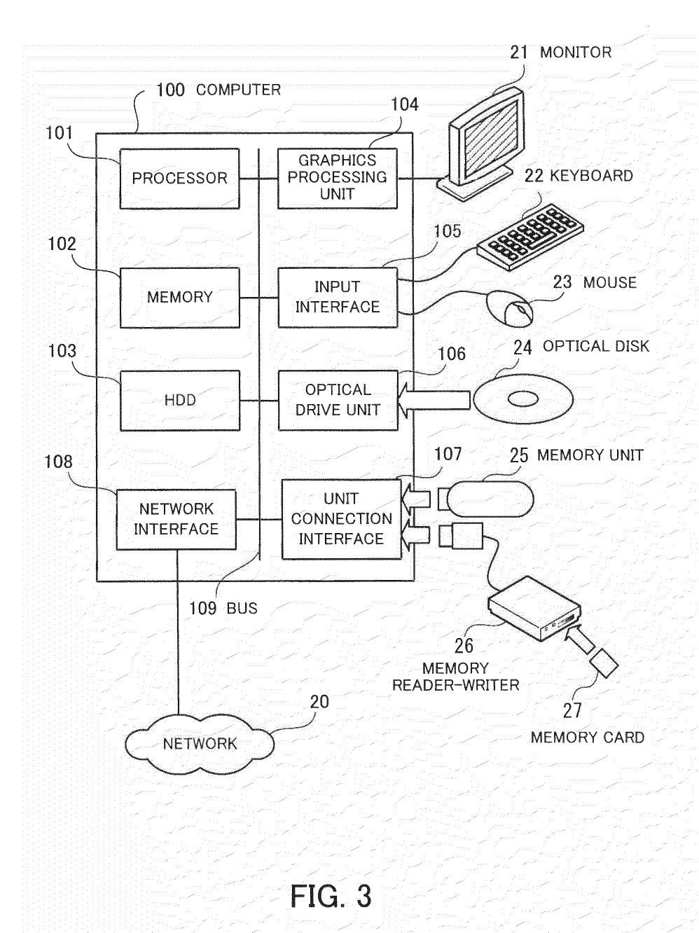

FIG. 3 illustrates an example of the hardware configuration of a computer used in the second embodiment. The whole of a computer 100 is controlled by a processor 101. A memory 102 and a plurality of peripheral units are connected to the processor 101 via a bus 109. The processor 101 may be a multiprocessor. The processor 101 is a CPU (Central Processing Unit), a MPU (Micro Processing Unit), a DSP (Digital Signal Processor), or the like. At least a part of the function of the processor 101 may be realized by an electronic circuit such as an ASIC (Application Specific Integrated Circuit) or a PLD (Programmable Logic Device).

The memory 102 is used as main storage of the computer 100. The memory 102 temporarily stores at least a part of an OS (Operating System) program or an application program executed by the processor 101. In addition, the memory 102 stores various pieces of data which the processor 101 needs to perform a process. A volatile semiconductor memory, such as a RAM (Random Access Memory), is used as the memory 102.

The plurality of peripheral units connected to the bus 109 are a HDD (Hard Disk Drive) 103, a graphics processing unit 104, an input interface 105, an optical drive unit 106, a unit connection interface 107, and a network interface 108.

The HDD 103 magnetically writes data to and reads out data from a built-in disk. The HDD 103 is used as auxiliary storage of the computer 100. The HDD 103 stores the OS program, application programs, and various pieces of data. A nonvolatile semiconductor memory, such as a flash memory, may be used as auxiliary storage.

A monitor 21 is connected to the graphics processing unit 104. The graphics processing unit 104 displays an image on a screen of the monitor 21 in accordance with an instruction from the processor 101. The monitor 21 is a display using a CRT (Cathode Ray Tube), a liquid crystal display, or the like.

A keyboard 22 and a mouse 23 are connected to the input interface 105. The input interface 105 transmits to the processor 101a signal transmitted from the keyboard 22 or the mouse 23. The mouse 23 is an example of a pointing device and another pointing device, such as a touch panel, a tablet, a touch pad, or a track ball, may be used.

The optical drive unit 106 reads data recorded on an optical disk 24 by the use of a laser beam or the like. The optical disk 24 is a portable record medium on which recorded data can be read by the reflection of light. The optical disk 24 is a DVD (Digital Versatile Disc), a DVD-RAM, a CD-ROM (Compact Disc Read Only Memory), a CD-R (Recordable)/RW (ReWritable), or the like.

The unit connection interface 107 is a communication interface used for connecting peripheral units to the computer 100. For example, a memory unit 25 and a memory reader-writer 26 are connected to the unit connection interface 107. The memory unit 25 is a record medium having the function of communicating with the unit connection interface 107. The memory reader-writer 26 is a unit which writes data to or reads out data from a memory card 27. The memory card 27 is a card-type record medium.

The network interface 108 is connected to a network 20. The network interface 108 transmits data to or receives data from another computer or a communication apparatus via the network 20.

By adopting the above hardware configuration, processing functions in the second embodiment are realized. The data search apparatus 10 according to the first embodiment is also realized by the use of the same hardware that is used in the computer 100 illustrated in FIG. 3.

The computer 100 realizes the processing functions in the second embodiment by executing a program recorded in, for example, a computer-readable record medium. The program in which the contents of a process that is to be performed by the computer 100 are described is recorded in various record media. For example, the program which is to be executed by the computer 100 is stored in the HDD 103. The processor 101 loads at least a part of the program stored in the HDD 103 into the memory 102 and executes it. Furthermore, the program which is to be executed by the computer 100 may be recorded on a portable record medium, such as the optical disk 24, the memory unit 25, or the memory card 27. The program recorded on a portable record medium is installed in the HDD 103 and then is executed, under the control of, for example, the processor 101. In addition, the processor 101 may read out the program directly from a portable record medium and execute it.

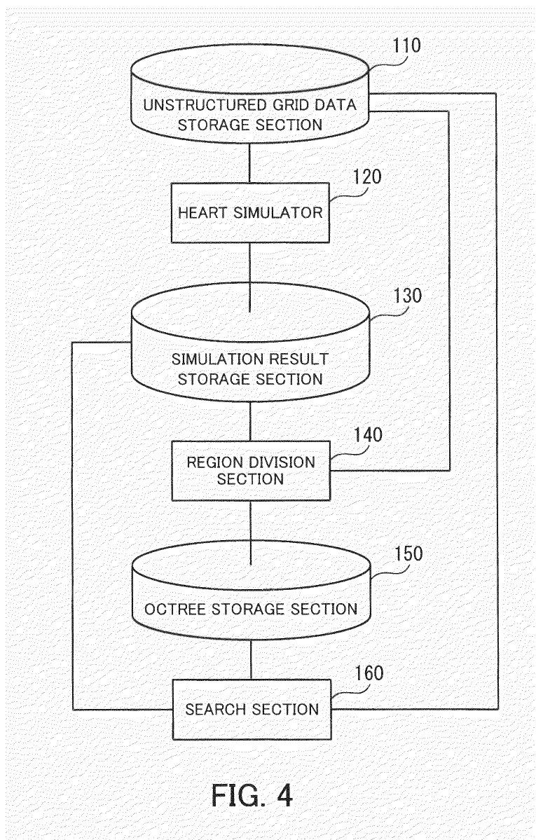

FIG. 4 is a functional block diagram of the computer according to the second embodiment. The computer 100 includes an unstructured grid data storage section 110, a heart simulator 120, a simulation result storage section 130, a region division section 140, an octree storage section 150, and a search section 160.

The unstructured grid data storage section 110 stores unstructured grid data which represents the shape of a heart in three dimensions. Unstructured grid data represents the shape of a heart by, for example, plural tetrahedral elements. In that case, many nodes are set in a space where there is a heart. Many tetrahedrons are defined and four nodes are the vertexes of each tetrahedron. For example, one tetrahedron is an element which represents a heart muscle cell of a heart. For example, a part of a storage area of the memory 102 or the HDD 103 is used as the unstructured grid data storage section 110.

The heart simulator 120 does a simulation of the motions of a heart including the pulsation on the basis of a three-dimensional model of the heart. The heart simulator 120 then stores simulation results in the simulation result storage section 130. For example, each time the heart simulator 120 makes the hour on a simulation progress by a determined time of period, the heart simulator 120 calculates the position of each node in the three-dimensional model and a physical amount at each element or node. The position of a node and a physical amount at each hour are calculated on the basis of the position of the node and a physical amount at the preceding hour. At a determined point of the hour on the simulation, the heart simulator 120 outputs as simulation results the position of each node and a physical amount at each element or node at the point.

The simulation result storage section 130 stores simulation results. For example, a part of the storage area of the memory 102 or the HDD 103 is used as the simulation result storage section 130.

In order to make it easy to make a search for a simulation result, the region division section 140 divides space including a three-dimensional model of a heart into plural regions on the basis of an octree. The region division section 140 then constructs a list of elements and nodes which belong to each region obtained by the division. The region division section 140 stores in the octree storage section 150 the regions generated on the basis of an octree and a list of elements and nodes which belong to each region as octree division data.

The octree storage section 150 stores octree division data. For example, a part of the storage area of the memory 102 and a part of the storage area of the HDD 103 are used as the octree storage section 150. In that case, an area which stores the upper structure of an octree is set in the memory 102 and an area which stores the lower structure of the octree is set in the HDD 103.

When any position in a three-dimensional model is designated, the search section 160 make a search for a physical amount at the position. For example, when an hour on a simulation is designated, the search section 160 reproduces a three-dimensional model of a heart at the designated hour on the basis of the position of each node stored in the simulation result storage section 130 and displays it. When any position in the reproduced three-dimensional model is designated next, the search section 160 searches the simulation result storage section 130 for an element or a node nearest the designated position. The search section 160 then displays a physical amount at a relevant element or node.

The simulation result storage section 130 is an example of the storage section 11 illustrated in FIG. 1. The region division section 140 is an example of the division section 12 illustrated in FIG. 1. The search section 160 is an example of the search section 14 illustrated in FIG. 1.

Lines which connect the components illustrated in FIG. 4 indicate a part of communication paths and a communication path other than those illustrated in FIG. 4 may be set. Furthermore, the function of each component illustrated in FIG. 4 is realized by, for example, making a computer execute a program module corresponding thereto.

An example of a data structure in the unstructured grid data storage section 110 will now be described.

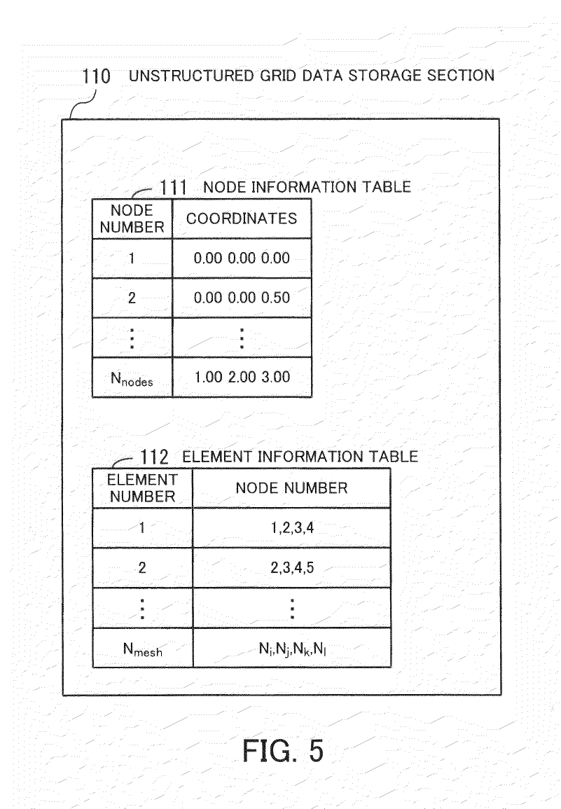

FIG. 5 indicates an example of a data structure in the unstructured grid data storage section. The unstructured grid data storage section 110 includes, for example, a node information table 111 and an element information table 112. Unstructured grid data is made up of the node information table 111 and the element information table 112. A node number of each node and coordinates indicative of its position are set in the node information table ill. The coordinates of each node set in the node information table 111 indicates its position before the beginning of simulation. After the pulsation of a heart is reproduced by simulation, the position of each node changes. An element number of each element which is a tetrahedron and node numbers of nodes which are its vertexes are set in the element information table 112.

A three-dimensional model of a heart is made on the basis of data stored in the unstructured grid data storage section 110 illustrated in FIG. 5.

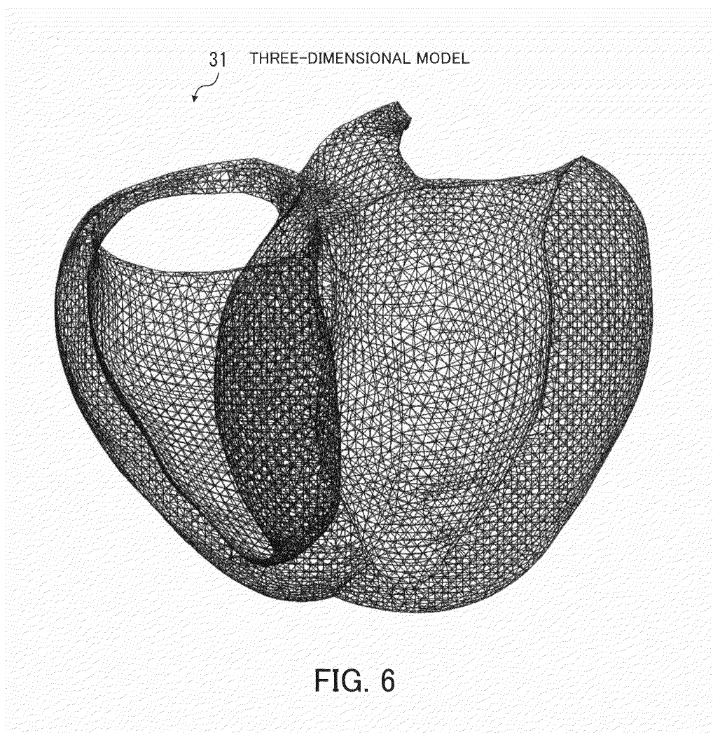

FIG. 6 illustrates an example of a three-dimensional model of a heart. In the example of FIG. 6, a three-dimensional model 31 is a set of tetrahedral elements. A simulation of the motions of the heart is done by giving conditions regarding the operation of the contraction and dilatation of heart muscles to the three-dimensional model 31. When a simulation is done, simulation results are stored in the simulation result storage section 130.

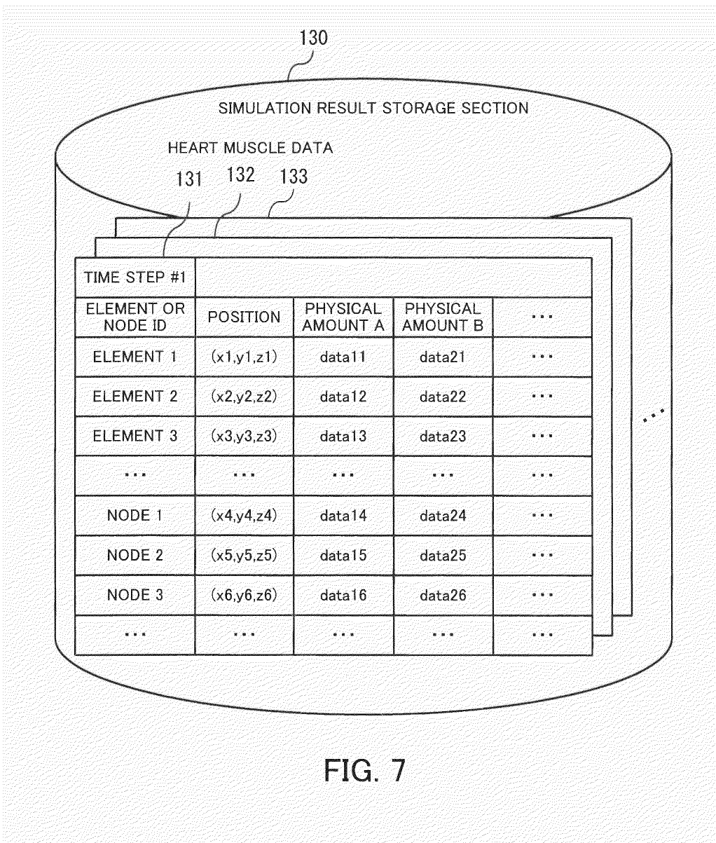

FIG. 7 indicates an example of a data structure in the simulation result storage section. The simulation result storage section 130 stores heart muscle data 131, 132, 133, and so on at different time steps. In this case, a point of time at which the results of one simulation are recorded is a time step. The heart muscle data 131, 132, 133, and so on is information indicative of the state of a heart at the time steps.

With the heart muscle data 131, 132, 133, and so on, for example, the position of an element or a node and one or more physical amount values are set and are associated with element or node ID. The position of an element is, for example, the position of the center of gravity of a tetrahedral element. Furthermore, a value may be set both at an element and at a node for one physical amount or be set only at an element or a node for one physical amount.

On the basis of the above heart muscle data 131, 132, 133, and so on at the different time steps, space where the three-dimensional model 31 of the heart resides is divided into plural regions in accordance with an octree.

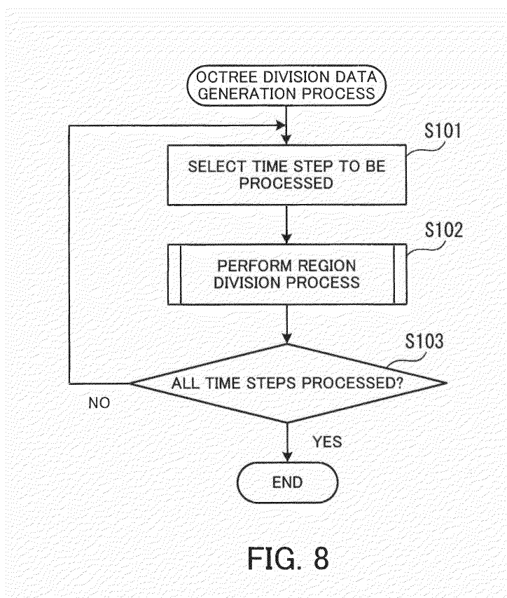

FIG. 8 is a flow chart of an example of a procedure for an octree division data generation process.

(Step S101) The region division section 140 selects a time step to be processed in order from the head of the time steps at which the heart muscle data 131, 132, 133, and so on is stored.

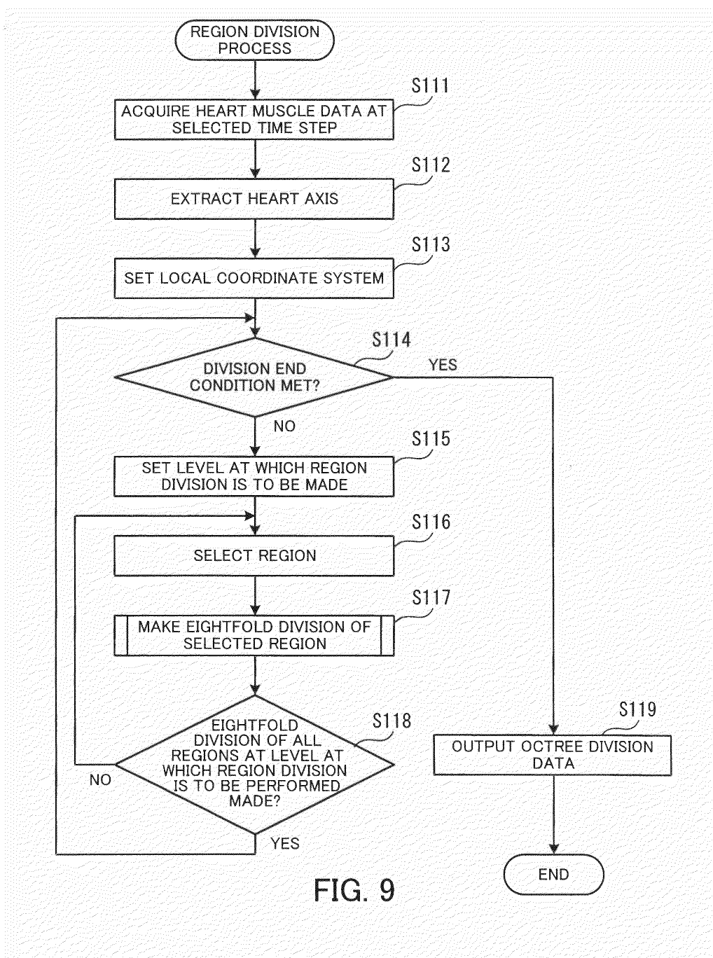

(Step S102) The region division section 140 performs a region division process on heart muscle data at the time step selected. The details of the region division process will be described later (see FIG. 9).

(Step S103) The region division section 140 determines whether or not it has performed the region division process on the heart muscle data at all the time steps. If the region division section 140 has performed the region division process on the heart muscle data at all the time steps, then the process ends. If there is a time step which is not yet processed, then the region division section 140 proceeds to step S101.

The details of the region division process will now be described.

FIG. 9 is a flow chart of an example of a procedure for the region division process.

(Step S111) The region division section 140 acquires heart muscle data at a selected time step from the simulation result storage section 130.

(Step S112) The region division section 140 extracts a heart axis on the basis of the acquired heart muscle data. For example, the region division section 140 grasps the shape of a heart at the selected time step on the basis of the acquired heart muscle data and unstructured grid data stored in the unstructured grid data storage section 110. The region division section 140 then considers as the heart axis a straight line which connects the apex of the left ventricle and the center of the valve region of the mitral valve. In this case, for example, information indicative of the position of the apex of the left ventricle and information indicative of the position of the valve region of the mitral valve are stored in advance in the unstructured grid data storage section 110.

(Step S113) The region division section 140 sets a local coordinate system having a coordinate axis parallel to the heart axis. For example, the region division section 140 sets an orthogonal coordinate system having a y-axis parallel to the heart axis and having an x-axis and a z-axis perpendicular to the y-axis.

(Step S114) The region division section 140 determines whether or not a division end condition is met. For example, if the size in the z direction of a divided region whose size in the z direction is the largest of all divided regions is smaller than or equal to a determined value, then the region division section 140 determines that a division end condition is met. Alternatively, if the level of division based on an octree (number of times subdivision is made by an eightfold division) reaches a determined level, then the region division section 140 may determine that a division end condition is met. If the division end condition is met, then the region division section 140 proceeds to step S119. If the division end condition is not met, then the region division section 140 proceeds to step S115.

(Step S115) The region division section 140 sets a level at which region division is to be made. For example, the region division section 140 generates a bounding box including the whole of the heart, and sets the level of a region surrounded by the bounding box to “level 0”. First the region division section 140 sets “level 0” as a level at which region division is to be made. The level of 8 regions obtained by making an eightfold division of the region whose level is “level 0” is “level 1”. Accordingly, the region division section 140 then sets “level 1” as a level at which region division is to be made. The region division section 140 sets in this way the level of regions generated by dividing a region at a level as a level at which region division is to be made next.

(Step S116) The region division section 140 selects one which is not yet divided from among regions at a level at which region division is to be made.

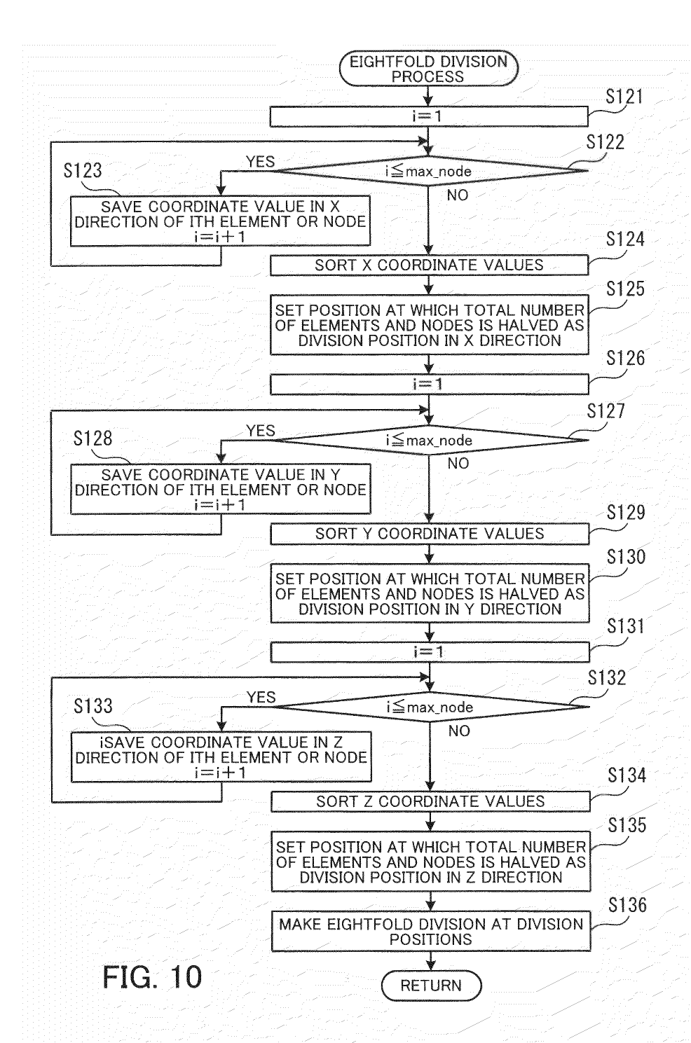

(Step S117) The region division section 140 makes an eightfold division of the selected region. The details of an eightfold division process will be described later (see FIG. 10).

(Step S118) The region division section 140 determines whether or not it has made an eightfold division of all the regions at the level at which region division is to be made. If the region division section 140 has made an eightfold division of all the regions at the level at which region division is to be made, then the region division section 140 proceeds to step S114. If there is a region which is not yet divided among all the regions at the level at which region division is to be made, then the region division section 140 proceeds to step S116.

(Step S119) When the division end condition is met, the region division section 140 outputs octree division data. For example, the region division section 140 stores in the octree storage section 150 information indicative of regions generated by division.

An eightfold division is repeated through the above procedure from the region including the whole of the heart. As a result, octree division data is generated. The eightfold division process will now be described in detail.

FIG. 10 is a flow chart of a procedure for an eightfold division process.

(Step S121) The region division section 140 sets to 1 a variable i indicative of the order of an element or a node to be selected.

(Step S122) The region division section 140 determines whether or not the value of i is smaller than or equal to the total number (max_node) of elements and nodes in a region to be divided. If the value of i is smaller than or equal to max_node, then the region division section 140 proceeds to step S123. If the value of i is larger than max_node, then the region division section 140 proceeds to step S124.

(Step S123) The region division section 140 saves in the memory 102 the coordinate value in the x direction of an ith element or node of arranged elements and nodes. The position of an element is, for example, its center of gravity. After the region division section 140 saves the coordinate value, the region division section 140 increments the value of the variable i (adds 1 to the value of the variable i) and proceeds to step S122.

(Step S124) If the value of i is larger than max_node, then the region division section 140 sorts saved x coordinate values by magnitude.

(Step S125) The region division section 140 sets a position in the x-axis direction at which the total number of the elements and the nodes is halved as a division position in the x direction of the region. For example, if max_node is an even number, then the region division section 140 sets as a division position a middle point of a “max_node/2”th value and a “(max_node/2)+1”th value of the x coordinate values after the sort. Furthermore, if max_node is an odd number, then the region division section 140 sets as a division position a “(max_node+1)/2”th value of the x coordinate values after the sort.

(Step S126) The region division section 140 sets the variable i to 1.

(Step S127) The region division section 140 determines whether or not the value of i is smaller than or equal to the total number (max_node) of the elements and the nodes in the region to be divided. If the value of is smaller than or equal to max_node, then the region division section 140 proceeds to step S128. If the value of i is larger than max_node, then the region division section 140 proceeds to step S129.

(Step S128) The region division section 140 saves in the memory 102 the coordinate value in the y direction of an ith element or node of the arranged elements and nodes. After the region division section 140 saves the coordinate value, the region division section 140 increments the value of the variable i (adds 1 to the value of the variable i) and proceeds to step S127.

(Step S129) If the value of i is larger than max_node, then the region division section 140 sorts saved y coordinate values by magnitude.

(Step S130) The region division section 140 sets a position in the y-axis direction at which the total number of the elements and the nodes is halved as a division position in the y direction of the region. For example, if max_node is an even number, then the region division section 140 sets as a division position a middle point of a “max_node/2”th value and a “(max_node/2)+1”th value of the y coordinate values after the sort. Furthermore, if max_node is an odd number, then the region division section 140 sets as a division position a “(max_node+1)/2”th value of the y coordinate values after the sort.

(Step S131) The region division section 140 sets to 1 the variable i indicative of the order of an element or a node to be selected.

(Step S132) The region division section 140 determines whether or not the value of i is smaller than or equal to the total number (max_node) of the elements and the nodes in the region to be divided. If the value of is smaller than or equal to max_node, then the region division section 140 proceeds to step S133. If the value of i is larger than max_node, then the region division section 140 proceeds to step S134.

(Step S133) The region division section 140 saves in the memory 102 the coordinate value in the z direction of an ith element or node of the arranged elements and nodes. The position of an element is, for example, its center of gravity. After the region division section 140 saves the coordinate value, the region division section 140 increments the value of the variable (adds 1 to the value of the variable i) and proceeds to step S132.

(Step S134) If the value of i is larger than max_node, then the region division section 140 sorts saved z coordinate values by magnitude.

(Step S135) The region division section 140 sets a position in the z-axis direction at which the total number of the elements and the nodes is halved as a division position in the z direction of the region. For example, if max_node is an even number, then the region division section 140 sets as a division position a middle point of a “max_node/2”th value and a “(max_node/2)+1”th value of the z coordinate values after the sort. Furthermore, if max_node is an odd number, then the region division section 140 sets as a division position a “(max_node+1)/2”th value of the z coordinate values after the sort.

(Step S136) The region division section 140 makes an eightfold division of the region to be divided at the division positions set in the x, y, and z directions. For example, first the region division section 140 makes a twofold division of the region to be divided by a plane passing through the division position in the x direction and parallel to a y-z plane. The region division section 140 then makes a twofold division of each of two regions obtained by making the twofold division by a plane passing through the division position in the y direction and parallel to a z-x plane. Finally, the region division section 140 makes a twofold division of each of four regions obtained by making the twofold division twice by a plane passing through the division position in the z direction and parallel to an x-y plane. As a result, an eightfold division of the region to be divided is made and eight regions are obtained.

By performing the processes indicated in FIGS. 9 and 10, an eightfold division of the region including the heart is made repeatedly and octree division data is generated.

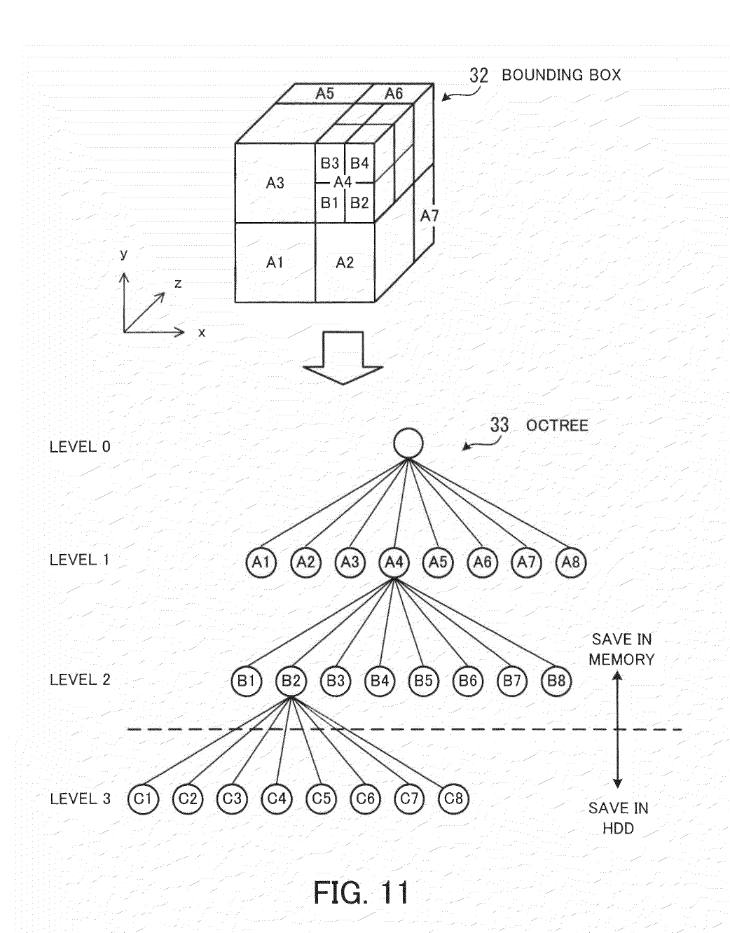

FIG. 11 illustrates an example of generating an octree. A region surrounded by a bounding box 32 includes many nested regions. A nest structure represented by a tree structure is an octree 33. Each node of the octree 33 represents a region. A root node of the octree 33 is the bounding box 32 including the whole of a heart. It is assumed that the level of the region surrounded by the bounding box 32 is, for example, “level 0”. 8 regions are obtained by making an eightfold division of the region at “level 0”. The level of the 8 regions is “level 1”. 64 regions are obtained by making an eightfold division of each region at “level 1”. The level of the 64 regions is “level 2”. Furthermore, 512 regions are obtained by making an eightfold division of each region at “level 2”. The level of the 512 regions is “level 3”.

Octree division data indicative of the octree 33 may be divided into two parts and be stored in the memory 102 and the HDD 103 respectively. For example, data corresponding to a structure above “level 3” is stored in the memory 102. Data corresponding to a structure below “level 2” is stored in files, for example, according to regions and is stored in the HDD 103.

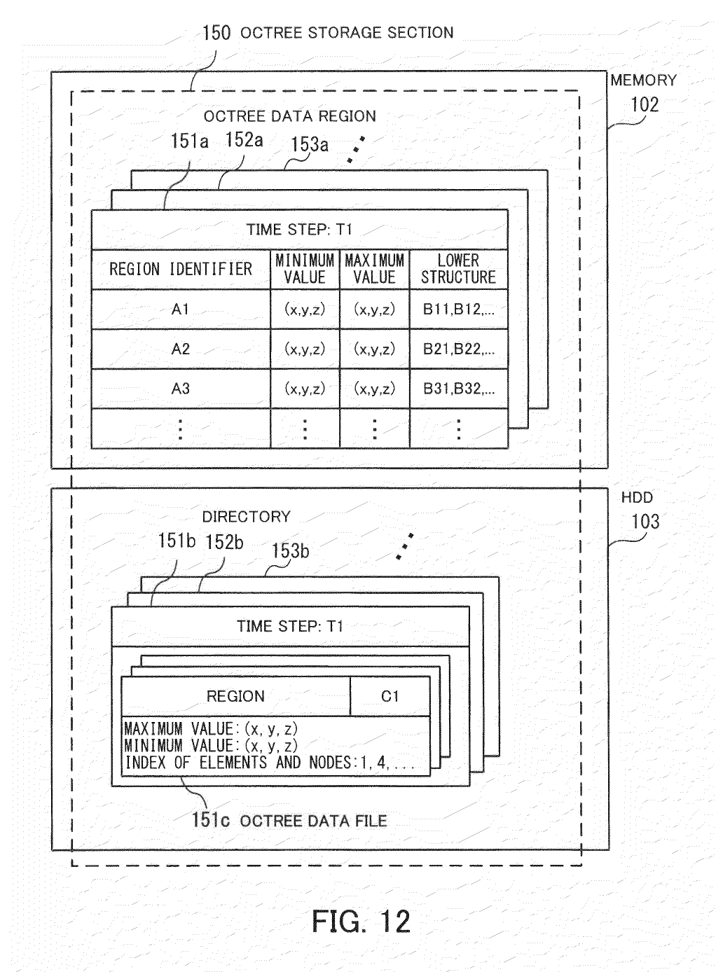

FIG. 12 indicates an example of a data structure in the octree storage section. The octree storage section 150 includes the storage area of the memory 102 and the storage area of the HDD 103. Octree data regions 151a, 152a, 153a, and so on corresponding to different time steps are set in the storage area of the memory 102 included in the octree storage section 150. In each of the octree data regions 151a, 152a, 153a, and so on, for example, a minimum value, a maximum value, and a lower structure are set and are associated with a region identifier. A minimum value in a region indicates the coordinates of a corner of the region nearest the origin of the local coordinate system. A maximum value in a region indicates the coordinates of a corner of the region which is the furthest from the origin of the local coordinate system. A lower structure in a region indicates an identifier of each region obtained by making an eightfold division of the region.

For example, directories 151b, 152b, 153b, and so on corresponding to the different time steps are set in the storage area of the HDD 103 included in the octree storage section 150. In each of the directories 151b, 152b, 153b, and so on, an octree data file 151c for each region in a lower structure in an octree at a corresponding time step is stored. Each octree data file 151c contains, for example, a minimum value, a maximum value, and an index of elements and nodes in a corresponding region. An index of elements and nodes is a list of identification numbers of elements in a corresponding region and identification numbers of nodes in the corresponding region.

On the basis of the above octree division data, a search for an element or a node at a position arbitrarily designated in a three-dimensional model by a user is made and a physical amount is displayed. A search process will now be described in detail.

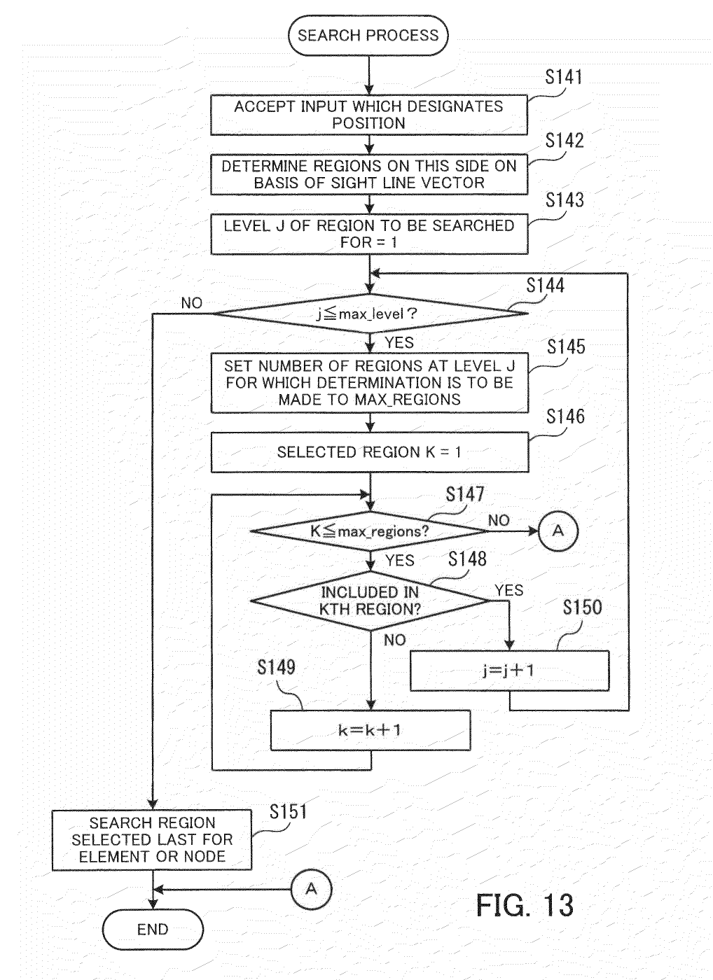

FIG. 13 is a flow chart of an example of a procedure for a search process.

(Step S141) The search section 160 accepts input which designates a position at which a physical amount is to be displayed. For example, the search section 160 displays a three-dimensional model of a heart on the monitor 21 on the basis of unstructured grid data stored in the unstructured grid data storage section 110 and heart muscle data at a determined time step. A user uses, for example, the mouse 23 for designating a position in the three-dimensional model at which he/she wants to know a physical amount. The designated position is two-dimensional values (X value, Y value) on the screen. The search section 160 determines a position in the three-dimensional model of the heart displayed at the designated position, and acquires three-dimensional values in the local coordinate system corresponding to the designated position.

(Step S142) The search section 160 determines regions on this side on the screen of the monitor 21 on the basis of a sight line vector. With the bounding box 32 illustrated in FIG. 11, for example, regions “A1” through “A7” are on this side. However, a region “A8” hides behind other regions and therefore is not on this side.

(Step S143) First the search section 160 sets a level j of a region to be searched for to “1”.

(Step S144) The search section 160 determines whether or not the value of j is smaller than or equal to the maximum value (max level) of levels generated on the basis of an octree. If the value of j is smaller than or equal to max level, then the search section 160 proceeds to step S145. If the value of j is larger than max level, then the search section 160 proceeds to step S151.

(Step S145) The search section 160 sets to a variable “max_regions” the number of regions at the level j for which determination is to be made. For example, if j=1, then the search section 160 sets regions, of regions obtained by dividing a region indicated by the bounding box 32 including the heart, which are on this side on the basis of the sight line vector as regions at the level j for which determination is to be made. Furthermore, if j>1, then the search section 160 sets regions, of regions obtained by dividing a region selected last in step S146, which are on this side on the basis of the sight line vector as regions at the level j for which determination is to be made.

(Step S146) The search section 160 numbers the regions at the level j for which determination is to be made. The search section 160 then sets a variable k indicative of a selected region to “1” and selects a kth region.

(Step S147) The search section 160 determines whether or not the value of k is smaller than or equal to max_regions. If the value of k is smaller than or equal to max_regions, then the search section 160 proceeds to step S148. If the value of k is larger than max_regions, then the determination that the designated position is outside the bounding box 32 including the heart is made and the process ends.

(Step S148) The search section 160 determines whether or not the position designated by the user is included in a selected region (kth region at the level j). For example, the search section 160 determines whether or not the coordinates of the designated position are included in a range indicated by a minimum value and a maximum value of the kth region. If the designated position is included in the selected region, then the search section 160 proceeds to step S150. If the designated position is not included in the selected region, then the search section 160 proceeds to step S149.

(Step S149) The search section 160 increments the value of the variable k (adds 1 to the value of the variable k), proceeds to step S147, and performs a process on the next region.

(Step S150) If the search section 160 detects a region at the level j including the designated position, then the search section 160 increments the value of j (adds 1 to the value of j) and proceeds to step S144.

(Step S151) The search section 160 searches elements or nodes in a region selected last for an element or a node nearest the designated position. For example, on the basis of an octree data file 151c (see FIG. 12) on the region selected last, the search section 160 recognizes the elements and the nodes in the region. The search section 160 then recognizes the positions of the elements and the nodes in the region selected last on the basis of heart muscle data indicative of the state of the three-dimensional model of the heart displayed. Furthermore, the search section 160 calculate the distance between the designated position and each of the elements and the nodes and specifies an element or a node nearest the designated position. The search section 160 then refers to heart muscle data at a time step to be processed and displays a physical amount at the specified element or node on the monitor 21.

If a type of a physical amount to be displayed is designated by the user, then the search section 160 displays a physical amount of the designated type. In addition, a physical amount set only at each element or each node may be designated as a physical amount to be displayed. In that case, the search section 160 searches for an element or a node, of elements or nodes in a region selected last, which is nearest a designated position.

A physical amount at a position designated by the user is displayed in this way on the monitor 21.

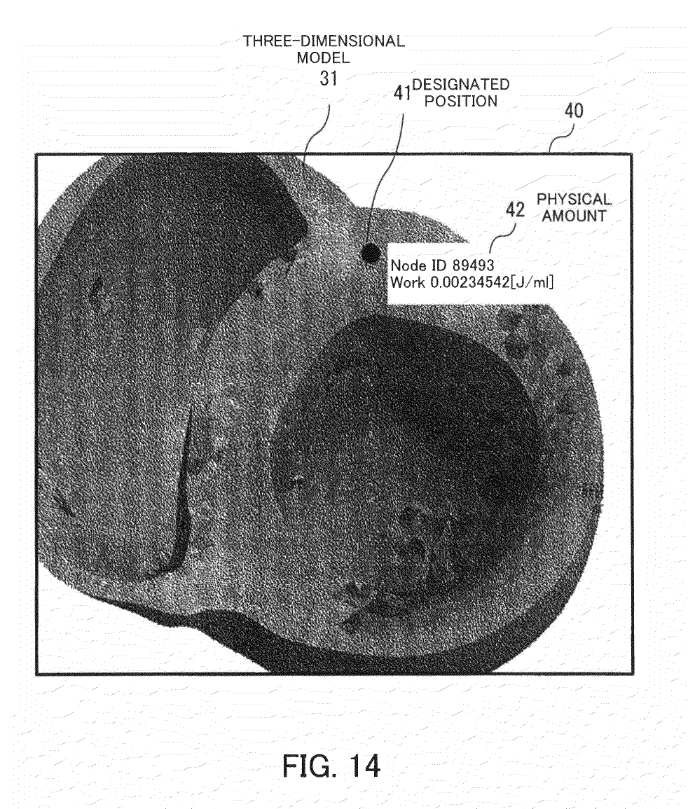

FIG. 14 indicates an example of the display of a physical amount. A three-dimensional model 31 is displayed on a screen 40 of the monitor 21. When any position (designated position 41) in the three-dimensional model 31 is designated by the user, a physical amount 42 at the position is displayed. In the example of FIG. 14, an identifier of an element or a node nearest the designated position 41 and the amount of energy per unit volume calculated at the element or the node are displayed.

As has been described, in the second embodiment the bounding box 32 including the heart is divided on the basis of an octree so as to make the number of elements and nodes included in each region at the same level equal. As a result, whichever region after the division includes a position designated by the user, the number of elements and nodes included in the region is the same. This checks a change is search time caused by a difference in region to which a designated position belongs. That is to say, when the user designates a position a physical amount at which is to be displayed, a physical amount is always displayed in approximately the same period of time. This averts, for example, a situation in which it takes a long time only in a certain case to display a physical amount.

A heart has a complex shape. In order to ascertain simulation results, in many cases observations are carried out on a cross section perpendicular to a heart axis which connects the apex of the left ventricle and the center of the valve region of the mitral valve. In the second embodiment the local coordinate system is defined so that its one coordinate axis will be parallel to the heart axis. That is to say, a region which surrounds the outside of the heart is set so that its one side will be parallel to the heart axis. As a result, when observations are carried out on a cross section perpendicular to the heart axis, the number of regions which are on this side on the basis of a sight line vector is minimized. Accordingly, a physical amount is displayed in a short period of time.

Furthermore, in the second embodiment data, of octree division data, corresponding to the upper levels of a tree structure is saved in the memory 102. Accordingly, a region including a position designated by the user is searched for at high speed.

### Third Embodiment

A third embodiment will now be described. In a third embodiment an octree division data generation process is performed efficiently. The differences between the second embodiment and a third embodiment will now be described.

There is not much change in the shape of a three-dimensional model between time steps close to each other. If time taken to perform a structuring process in which a bounding box including the three-dimensional model is divided on the basis of an octree is taken into consideration, to perform the structuring process at all time steps is inefficient. Therefore, in the second embodiment a key time step is determined according to the amount of a change and octree division data is generated at the key time step. Furthermore, the octree division data at the key time step is copied and is used as octree division data at a time step which is not the key time step.

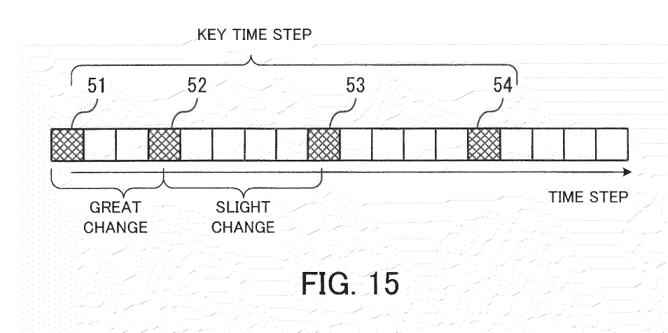

FIG. 15 illustrates an example of a key time step. For example, first a leading time step is set as a key time step 51. A spatial change in three-dimensional model of a heart at each time step after the key time step 51 is ascertained. A spatial change is determined, for example, by a change in the size of a bounding box used for generating an octree. Alternatively, a spatial change may be determined by a change in the position at which a bounding box is divided. A spatial change is represented, for example, by a change rate. In that case, when a change rate at a time step exceeds a certain rate with the preceding key time step as reference, the time step is set as a key time step. In the example of FIG. 15, key time steps 51 through 54 are set.

Intervals between the key time steps 51 through 54 change according to the degree of a change in the shape of the three-dimensional model. If there is a great change, the interval between key time steps becomes close. On the other hand, if there is a slight change, the interval between key time steps becomes wide.

An octree formation process is performed on all elements and nodes at key time steps. At another time step space division made at the preceding key time step is taken over and copy is performed.

A region division process in the third embodiment differs in detail from that in the second embodiment.

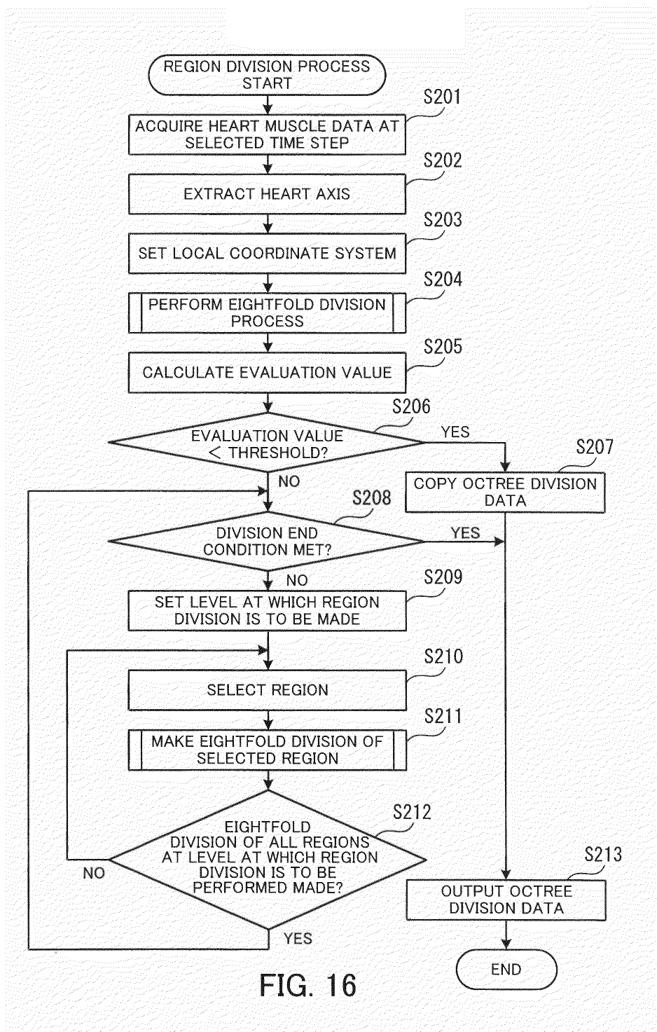

FIG. 16 is a flow chart of an example of a procedure for a region division process in the third embodiment. Steps S201 through S203 and S208 through S213 indicated in FIG. 16 are the same as steps S111 through S119, respectively, indicated in FIG. 9. Steps S204 through S207 of FIG. 16 which are not indicated in FIG. 9 will now be described.

(Step S204) The region division section 140 makes an eightfold division of a bounding box including the whole of a heart. The details of the eightfold division process are described in FIG. 10.

(Step S205) The region division section 140 calculates an evaluation value indicative of the degree of a change after the preceding time step. For example, the region division section 140 compares each region which is obtained by making an eightfold division of the bounding box including the whole of the heart and which is included in octree division data at the preceding time step with each region generated in step S204, and finds a similarity degree.

For example, a division position comparison method may be used as a method for calculating a similarity degree. In this case, the region division section 140 calculates a division position Xdiv in the x direction at each of a selected time step (time step (n+1)) and the preceding time step (time step n) at the time of making an eightfold division of the bounding box including the whole of the heart. The region division section 140 then calculates an evaluation value by the use of

|Xdiv_{—}n−(Xdiv_{—}n+1)|/Xdiv_{—}n (1)

where “Xdiv_n” is a division position in the x direction at the preceding time step (time step n) and “Xdiv_n+1” is a division position in the x direction at the selected time step (time step (n+1)). Formula (I) represents the ratio of a difference in the distance between the origin and a division position to the distance between the origin and the division position at the preceding time step. A calculation result obtained by the use of formula (I) is an evaluation value. In this case, as a value obtained by the use of formula (I) becomes larger, a greater change in the shape of the heart occurs after the preceding time step before the selected time step.

(Step S206) The region division section 140 determines whether or not the evaluation value is smaller than a threshold. For example, the region division section 140 determines whether the following inequality (2) is true or false.

|Xdiv_{—}n−(Xdiv_{—}n+1)|/Xdiv_{—}n<α (2)

where α is a constant greater than 0 and smaller than 1. If the evaluation value is smaller than the threshold, then the region division section 140 proceeds to step S207. If the evaluation value is greater than or equal to the threshold, then the region division section 140 proceeds to step S208.

(Step S207) The region division section 140 copies the octree division data at the preceding time step (time step n) and uses it as octree division data at the selected time step (time step (n+1)). For example, it is assumed that α is 0.01. In that case, if a deviation between the division position in the x direction at the preceding time step and the division position in the x direction at the selected time step is smaller than 1 percent of the distance between the origin and the division position at the preceding time step, then the region division section 140 copies the octree division data. That is to say, octree division data at the selected time step is octree division data obtained by making division at the same division position that is used at the preceding time step. After that, the region division section 140 proceeds to step S213.

As has been described, if a change in the shape of the heart obtained by doing a simulation is slight, then octree division data which is already generated is copied. As a result, a process is efficiently performed. In the example of FIG. 16, a comparison is made between the octree division data at the preceding time step and the octree division data at the selected time step. However, a comparison may be made, for example, between octree division data at the preceding key time step and the octree division data at the selected time step.

In the second and third embodiments a region is divided on the basis of an octree. However, a region may be divided on the basis of another tree structure such as a quad tree.

Furthermore, in the second and third embodiments a physical amount obtained by doing a simulation of a heart is displayed. However, a physical amount obtained by doing a simulation of an internal organ other than a heart can be displayed in the same way. In addition, by making the same search that is described in the second or third embodiment, various pieces of information set at any position in a three-dimensional model of an internal organ or a living body other than the internal organs can be displayed.

The embodiments have been described in the foregoing. However, a component indicated in each embodiment may be replaced with another unit having the same function. Furthermore, any other component or process may be added. In addition, the structure (characteristics) of any two or more of the above embodiments may be combined.

According to an aspect, whichever position is selected to ascertain a physical amount, it does not take a long time to make a search.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A data search apparatus comprising:
a memory configured to store positional information and a physical amount for each of a plurality of physical amount set points arranged in a three-dimensional model; and
a processor configured to execute a process including:
generating division data corresponding to each of a plurality of second regions obtained by dividing a first region including the three-dimensional model so as to make a number of physical amount set points included in each second region equal, and
acquiring, at the time of a position in the three-dimensional model being designated, from the memory a physical amount for a physical amount set point corresponding to the designated position of physical amount set points which division data corresponding to a second region, of the plurality of second regions, including the designated position includes.

2. The data search apparatus according to claim 1, wherein the generating includes:
dividing the first region;
repeatedly dividing each of regions obtained by division;
generating a tree structure in which regions obtained by division are connected to a divided region; and
considering a plurality of regions corresponding to leaves of the generated tree structure as the plurality of second regions.

3. The data search apparatus according to claim 2, wherein:
the data search apparatus further includes main storage and is connected to auxiliary storage; and
the generating includes:
storing in the main storage a determined range of the tree structure from a top on a first area side; and
storing in the auxiliary storage a part, excluding the determined range, of the tree structure.

4. The data search apparatus according to claim 1, wherein:
the memory stores positional information and a physical amount for each of the plurality of physical amount set points for each of a plurality of shapes formed by changing a shape of the three-dimensional model; and
the generating includes generating the division data for each of the plurality of shapes.

5. The data search apparatus according to claim 4, wherein the generating includes using, at the time of a difference between a first shape for which division data is already generated and a second shape for which division data is to be generated being in a determined range, a copy of the division data for the first shape as the division data for the second shape.

6. A method for controlling a data search apparatus including a memory which stores positional information and a physical amount for each of a plurality of physical amount set points arranged in a three-dimensional model and a processor, the method comprising:
generating, by the processor, division data corresponding to each of a plurality of second regions obtained by dividing a first region including the three-dimensional model so as to make a number of physical amount set points included in each second region equal; and
acquiring, by the processor, at the time of a position in the three-dimensional model being designated, from the memory a physical amount for a physical amount set point corresponding to the designated position of physical amount set points which division data corresponding to a second region, of the plurality of second regions, including the designated position includes.

7. A computer-readable, non-transitory record medium storing a program that causes a data search apparatus including a memory which stores positional information and a physical amount for each of a plurality of physical amount set points arranged in a three-dimensional model to execute a process comprising:
generating division data corresponding to each of a plurality of second regions obtained by dividing a first region including the three-dimensional model so as to make a number of physical amount set points included in each second region equal; and
acquiring, at the time of a position in the three-dimensional model being designated, from the memory a physical amount for a physical amount set point corresponding to the designated position of physical amount set points which division data corresponding to a second region, of the plurality of second regions, including the designated position includes.
